(19) United States
(12) Patent Application Publication
(10) Pub. No.: US 2018/0131525 A1
(43) Pub. Date: May 10, 2018

(54) ESTABLISHING A SECURE CONNECTION ACROSS SECURED ENVIRONMENTS

(71) Applicant: International Business Machines Corporation, Armonk, NY (US)

(72) Inventor: Eric Kass, Mannheim (DE)

(21) Appl. No.: 15/345,150

(22) Filed: Nov. 7, 2016

(51) Int. Cl. H04L 9/32; H04L 29/06; H04L 29/08; H04L 12/66

(52) U.S. Cl. CPC H04L 9/3268; H04L 63/02; H04L 63/0823; H04L 12/66; H04L 63/101; H04L 67/141; H04L 67/42; H04L 63/123

(57) ABSTRACT

Disclosed aspects relate to establishing a secure communication connection between a server and a client. The server and a gateway reside within a first network realm. The server's public key certificates are signed by a certifying authority not certifiable from a the client residing within a second network realm. Aspects relate to verifying a server's certificate signed by a certificate authority of the first network realm before establishing the communication connection between the server and the client. Aspects relate to verifying a client's certificate signed by a certificate authority of the second network realm before establishing the communication connection between the server and the client. Aspects relate to verifying, a trusted secure gateway's certificate signed by a public key certificate authority certifiable from the client's network before establishing the communication between the server and the client.

### BACKGROUND

This disclosure relates generally to establishing a verifiable, secure communication connection between a server and a client, and more particularly, establishing a communication connection using a trusted secure gateway.

Communication links between enterprises are ever-increasing. Additionally, services and customer care for a computing environment of an enterprise may be delivered via e.g., remote login from a service provider's computer—in the context of this document ‘the client’—to a server—in the context of this document ‘the server’. Such services may be purchased as a part of a support contract. Because of high costs and scarce resources, the support is often provided remotely by the provider. For that, providers connect to the customers' networks over methods like virtual private networks (VPN); but even if VPN connections may provide a secure connection from the provider's network to the customer's network, it doesn't inherently provide a directly encrypted connection between the provider's host and the customer's host. However, such security measures may be requirements for certain customer/provider relationships.

### SUMMARY

Aspects of the disclosure relate to establishing a verifiable secure communication connection between a server and a client may be provided. The communication connection between the server and a client is using a trusted secure gateway. The server and the trusted secure gateway may reside within a first network realm. The server's public key certificates may be signed by a certifying authority not certifiable from the client residing within a second network realm different to the first network realm. Aspects may comprise verifying, by the trusted secure gateway, a certificate of the server signed by a certificate authority of the first network realm before establishing the communication connection between the server and the client. The trusted secure gateway may be trusted by the server. Aspects may also comprise verifying, by the trusted secure gateway, a certificate of the client signed by a certificate authority of the second network realm before establishing the communication connection between the server and the client. Additionally, aspects may comprise verifying, by the client, a certificate of the trusted secure gateway signed by a public key certificate authority certifiable from the client's network before establishing the communication between the server and the client, and establishing, via the trusted secure gateway, the communication connection between the client and the server if authorized by an access control list residing on the trusted of the trusted secure gateway. The access control list may be indicative of allowed communication connections out of systems of the first network realm and into systems of the first network realm.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

It should be noted that embodiments of the disclosure are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present disclosure are apparent from the examples of embodiments to be described hereinafter and are explained with reference to the examples of embodiments, but to which the invention is not limited.

Embodiments may be described, by way of example, and with reference to the following drawings:

FIG. 1 shows a block diagram of an embodiment for establishing a verifiable secure communication connection between a server and a client.

FIG. 2 shows a block diagram of exemplary involved systems for performing disclosed aspects.

FIG. 3 shows a block diagram of an embodiment of a data exchange/protocol diagram.

FIG. 4 shows a block diagram of a second embodiment of a data exchange/protocol diagram.

FIG. 5 shows a block diagram of an SSL flow according to embodiments.

FIG. 6 shows an SSL flow.

FIG. 7 shows an embodiment of a block diagram of an embodiment for establishing a verifiable secure communication connection between a server and a client.

FIG. 8 shows a block diagram of a computer system for performing aspects described herein.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

A customer may desire that a service provider securely connects to a host from within the service provider's network to the network of the customer. The hosts of the customer remain in the private environment but are accessible by the hosts of the service provider (e.g., via VPN or Firewall access). Because servers of the customer are private, they may be configured with, e.g., SSL (secure socket layer) certificates signed by the customer's local certifying authority. The service provider may not have access to the customer's certifying authority. Therefore, the customer's computer cannot validate date certificates sent by the service provider's computer during SSL exchange. In this context it may be desirable to establish a trusted and secure communication connection from the client computer of the service provider to the server of the customer, and back.

In the context of this description, the following conventions, terms and/or expressions may be used:

The term ‘secure communication connection’ may denote a digital data exchange path between two entities, i.e., a sender and a receiver, for a message such that a third party may be unable to read the message. Hence, the communication connection may not be interceptive or be compromised.

The term ‘server’ may denote any computer or communication system being installed in a first computing environment, i.e., in a first network realm of, e.g., a customer of a service provider. For the context of this document, any communication connection from any of the servers in the first network realm outside of this network environment may be directed through a trusted secure gateway.

The term ‘client’ or client system, or client computer, may denote any computer or communication system being installed in a second computing environment, i.e., in a second network realm of, e.g., of the service provider. The communication from any of the clients to any of the servers in the first network realm may always flow through the trusted secure gateway. The expression ‘client’ may not be intermixed with a client computing device such as a personal computer in the sense of client/server computing. The ‘client’ may also be a server; however, such a server may not be installed in the first network environment, i.e., not in the network environment of e.g., a customer, but in the second network environment of e.g., a vendor or service provider for the customer.

The term ‘trusted secure gateway’ may denote a computer system or server for establishing communication connections from inside the first network realm to outside the first network realm, i.e., into and out of a company's network environment.

The term ‘first network realm’ may denote the network environment of a first enterprise. Connections from the outside of such a network environment may be enabled by a gateway system.

The term ‘public key certificates’—also known as a digital certificate or identity certificate—may denote an electronic document used to prove ownership of a public key. The certificate includes information about the key, information about its owner's identity, and a digital signature of an entity that has verified that the certificate's contents are correct. If the signature is valid, and the person examining the certificate trusts the signer, then they know they can use that key to communicate with its owner.

In a typical public-key infrastructure (PKI) scheme, the signer may be a certificate authority (CA), usually a company that charges customers to issue certificates for them. In a web of trust scheme, the signer may either be the key's owner (a self-signed certificate) or other users (“endorsements”) whom the person examining the certificate might know and trust.

Certificates are an important component of Transport Layer Security (TLS, sometimes called by its older name SSL, Secure Sockets Layer), where they prevent an attacker from impersonating a secure website or other server. They may also be used in other important applications, such as email encryption and code signing.

The term ‘certifying authority’ or certificate authority or certification authority (CA) may denote an entity that issues digital certificates. A digital certificate may certify the ownership of a public key by the named subject of the certificate. This may allow others (relying parties) to rely upon signatures or on assertions made about the private key that corresponds to the certified public key. In this model of trust relationships, a CA is a trusted third party—trusted both, by the subject (owner) of the certificate and by the party relying upon the certificate. Many public-key infrastructure (PKI) schemes feature CAs.

The term ‘access control list’ may denote a list of permissions attached to a communication connection object. An ACL may specify which users or systems may be granted access to an object, as well as what operations are allowed on given objects. Each entry in a typical ACL may specify specific endpoints for a communication connection. As an example, the access control list may specify whether a server in the first network realm may be allowed to be digitally connected to another named server in a second network realm.

The term ‘symmetric key’ may be related to algorithms for cryptography that uses the same cryptographic keys for both, encryption of plaintext and decryption of ciphertexts. The keys may be identical or there may be a simple transformation to go between the two keys. The keys, in practice, represent a shared secret between two or more parties that can be used to maintain a private information link.

Aspects of the disclosure such as for establishing a verifiable secure communication connection between a server and a client may offer multiple advantages and technical effects:

A trusted communication path between a service organization providing services over a network to a customer operating a plurality of servers may be established without the usage of one central certificate server. Disclosed aspects may enable a secure and trusted identification of servers of a customer as well as a secure and trusted identification of computer systems of a service provider. A gateway in the network realm of the customer receiving the services from a service provider's organization may operate as a trusted translator of certificates and encryption keys between the customer's computers and the service provider's computers.

The protocol for an initiation of the trusted verifiable communication connection may be seen as an enhancement to the traditional SSL protocol (secure socket layer protocol). The server's owner may always be sure that only allowed service provider computers access the servers in the customer's network realm. On the other side, the service provider is ensured that he only accesses servers of certified customers.

It may be noted that the same technology may be used for a secure, verifiable communication connection between any other entities. The method is not limited to a customer/service provider relationship. However, this example is used as a typical implementation scenario.

According to embodiments, it may also comprise a verification, by the server, of a certificate of the trusted secure gateway signed by the public key certificate authority certifiable from the server's network realm before establishing the communication connection between the server and the client. This step may also be seen as a completion of the establishing the communication connection, after the client may have initiated the establishment of the communication connection. Thus, the trusted secure gateway is always in control of any communication inside or outside of the first network realm.

According to embodiments, the certificate authority of the second network realm may be a local certificate authority of the client or a well-trusted 3rd party certificate authority. Hence, systems of the second network realm may rely on public certification authorities. Alternatively, they may use private verification authorities. Disclosed aspects may be implemented using those alternatives. However, the certification authority is not the private certificate authority of the first network realm.

According to one further embodiment of the method, the verifying, by the trusted secure gateway, the server's certificate may represent an authentication of the server, and the verifying, by the trusted secure gateway, the client's certificate may represent an authentication of the client. Hence, the trusted secure gateway may ensure, in a secure way, the identities of the server and the client, i.e., inside and outside the first network realm.

According to one permissive embodiment of the method, a first symmetric key may be exchanged between the client and the trusted secure gateway, and a second symmetric key may be exchanged between the server and the trusted secure gateway, wherein an inbound communication to the trusted secure gateway may be decrypted by the first symmetric key before being encrypted with a second symmetric key before being transmitted by the trusted secure gateway. This may have the advantage that inside the first network realm and outside the first network realm always different encryption/decryption keys are used. Using this feature, a direct communication from the server in the first network realm to the client outside the first network realm—i.e., in the second network realm—is not possible due to the different encryption keys. The trusted secure gateway is always in control.

According to one possible embodiment, the method may also comprise exchanging a single symmetric key between the client and the server. Thus, an inbound communication to the trusted secure gateway may be transmitted directly without requiring decryption and/or re-encryption. This feature may reduce the computational effort in the trusted secure gateway. Therefore, a communication link between the client and server may be established using a higher data transfer rate.

According to embodiments, the trusted secure gateway may perform a port-forwarding for a determination of a specific server in the first network realm to be connected to the client. Thus, various technologies may be utilized. This may avoid additional programming, installation and/or configuration efforts at the trusted secure gateway side.

According to one optional embodiment of the method, the trusted secure gateway may act as SOCKS5 or HTTP proxy for a determination of a specific client in the second network realm that is to be connected to the server. A skilled person may know that socket secure′ (SOCKS) is an Internet protocol that exchanges network packets between a client and a server through a proxy server. SOCKS5 additionally provides authentication, so only authorized users may access a server. Practically, a SOCKS server may proxy TCP connections to an arbitrary IP address, and may provide a means for UDP packets to be forwarded.—SOCKS performs at Layer 5 of the OSI model (the session layer, an intermediate layer between the presentation layer and the transport layer). This way, disclosed aspects may make use of the latest Internet standards. However, the method may also be used with a more traditional Internet protocol.

According to one additionally advantageous embodiment of the method, the trusted secure gateway may log all accesses of all communication connections between any of the servers in the first network realm and any of the clients in the second network realm. Hence, a complete traceability of all communication connections may be established. Such a feature may be an advantage, or even a requirement, in an ITIL (Information Technology Infrastructure Library) environment and may be a synonym for well-defined processes of managing information technology environments. For the further enhancement of this embodiment, the logging data may comprise at least one selected out of the group comprising a network addresses, an access time, the communication connection duration, a verified public certificate of the client and the server. This may increase the traceability of the established communication connections via the trusted secure gateway.

In the following, a detailed description of the figures will be given. All instructions in the figures are schematic. Firstly, a block diagram of an embodiment of the inventive method for establishing a verifiable secure communication connection between a server and a client is given. Afterwards, further embodiments as well as embodiments of the system for establishing a verifiable secure communication connection between a server and a client will be described.

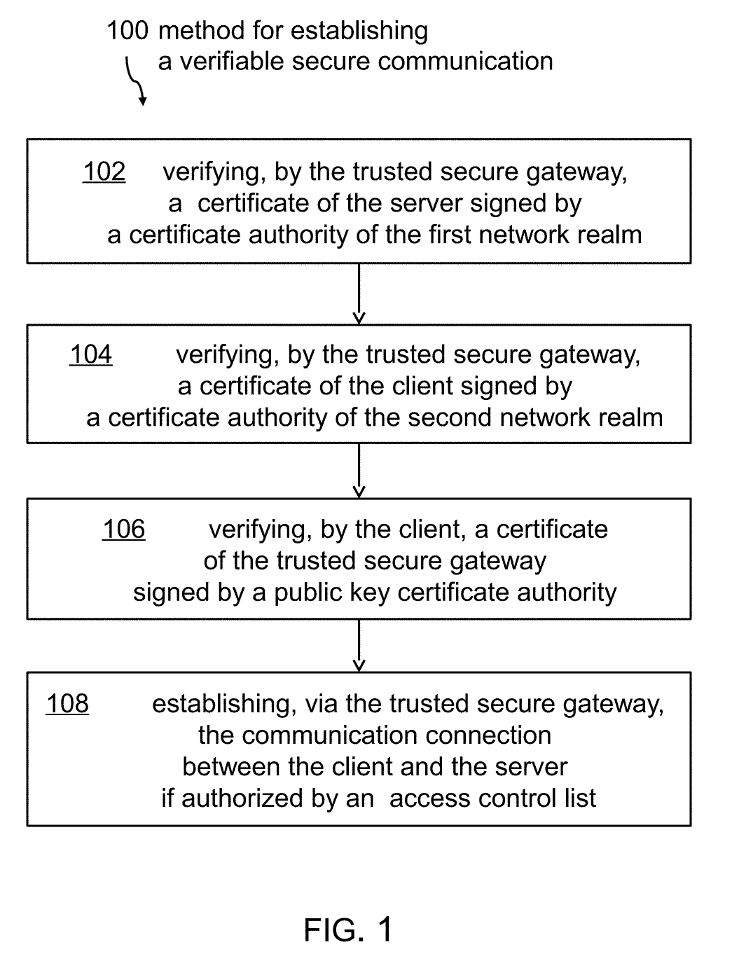

FIG. 1 shows a block diagram of an embodiment of the method 100 for establishing a verifiable secure communication connection between a server—of e.g., an enterprise—and a client—e.g., a service provider's computer—using a trusted secure gateway—in particular a system named rootXchange. The server and the trusted secure gateway reside within a first network realm, i.e., on the customer side. The server's public key certificates are signed by a certifying authority not certifiable from the client residing within a second network realm different to the first network realm. The method comprises verifying, 102, by the trusted secure gateway, a certificate of the server signed by a certificate authority of the first network realm before establishing—here in a 1st step or initiating—the communication connection between the server and the client, wherein the trusted secure gateway is trusted by the server.

The method comprises as well that the client computer is really the client computer and not an intruder by verifying, 104, by the trusted secure gateway, a certificate of the client signed by a certificate authority of the second network realm before establishing—here in a completion step—the communication connection between the server and the client.

Furthermore, the method comprises verifying, 106, by the client, a certificate of the trusted secure gateway signed by a public key certificate authority certifiable from the client's network before establishing the communication between the server and the client. Now the client computer as well as the server computer are identified and classified as being trusted.

Finally, the method comprises establishing, 108, via the trusted secure gateway, the communication connection between the client and the server if authorized by an access control list residing on the trusted secure gateway. The access control list is indicating of allowed communication connections out of systems of the first network realm and into systems of the first network realm.

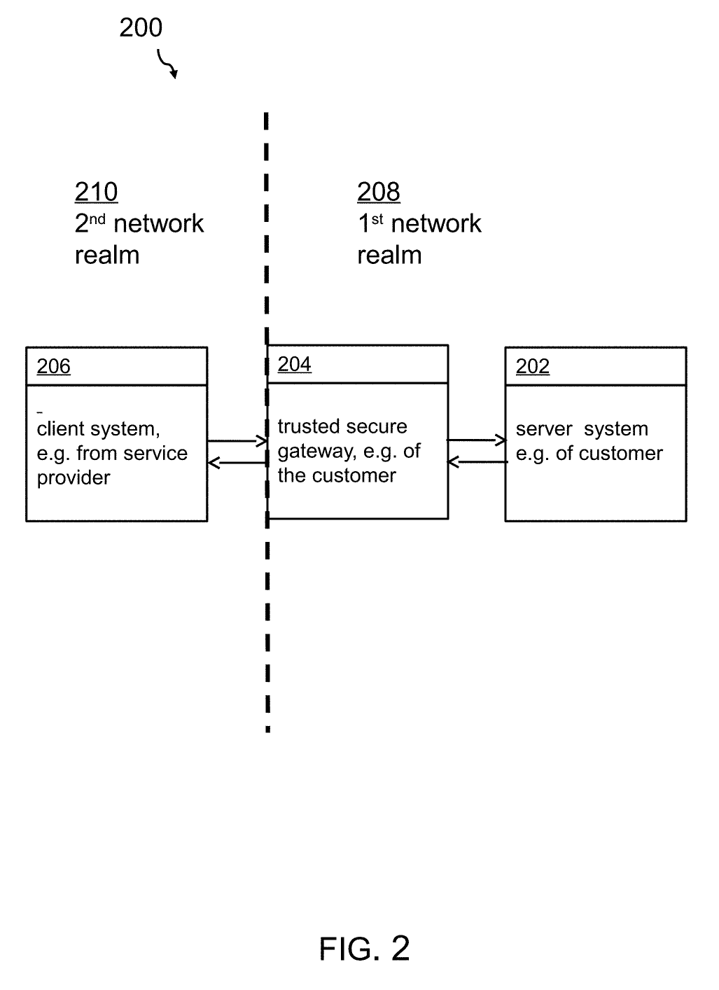

FIG. 2 shows a block diagram 200 of exemplary entities for performing aspects of the disclosure: a server computer 202, a client computer or client system 206 and a trusted secure gateway computer 204. It may be noted that the relationship between the client, the server and the trusted secure gateway 204 are discussed in the context of a customer (server) and service provider (client) relationship. It may be noted that any other entities may implement the establishing a verifiable secure communication connection between a server and a client using a trusted secure gateway. The two-way communication between the entities is shown as a double arrow. It may be noted that no direct communication between the server 202 and the client 206 exists.

It may also be noted, that the server 202 and the trusted secure gateway 204 are shown as belonging to the first network realm 208 of, e.g., a customer network environment. On the other side, the client computer 206 is shown as belonging to a second network realm 210 belonging to e.g., a network environment of a service provider. There is no central certification authority shown which may act as central trusted authority. Instead, a communication connection having the same trust-ability is established using aspects described herein.

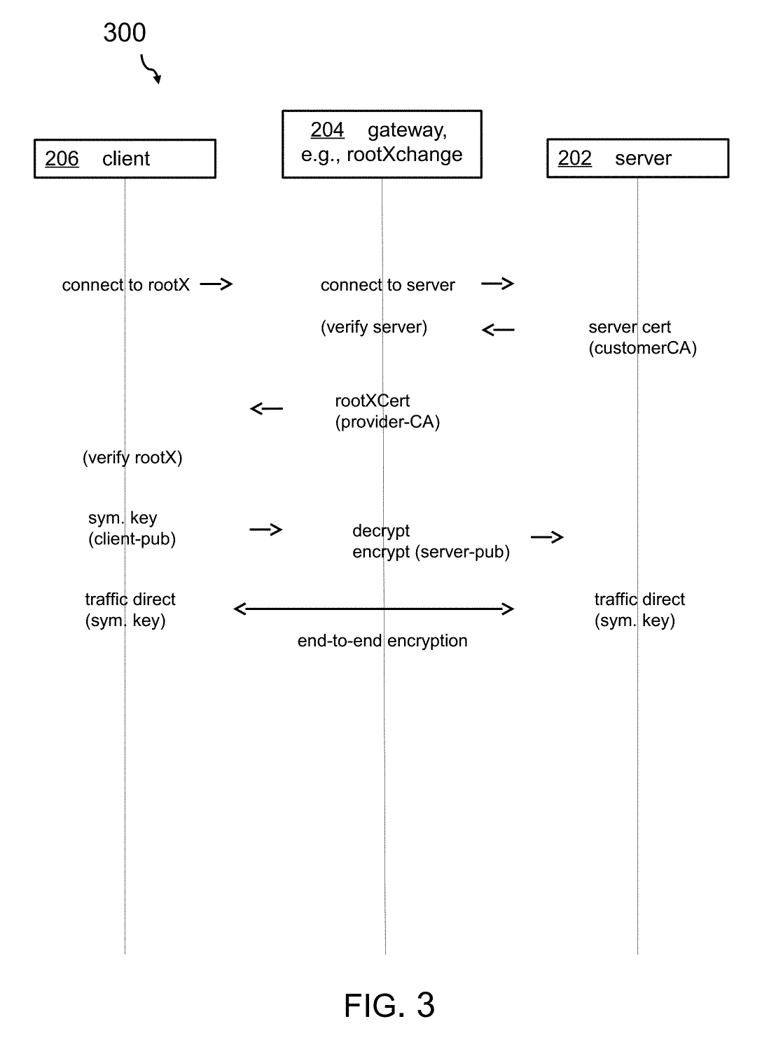

FIG. 3 shows a block diagram of an embodiment of a data exchange/protocol diagram 300 for disclosed aspects. Again, the client 206, the trusted secure gateway 204 and the server 202 are shown. A skilled person will be able to interpret the self-explanatory protocol diagram without any additional description. It may be noted that activities are shown in round brackets and that the trusted secure gateway is denoted here as rootXchange, as mentioned above. Consequently, “rootX” is an abbreviation of rootXchange. Other expressions in round brackets relate to the certification authority used as well as the kind of key used; e.g., “client-pub” may denote the public part of an encryption key pair in a public/private key environment, here the one from the client system. The initiation of the establishing of a trusted communication connection is shown as starting from the client 206 computer's side. However, the initiation may also come from the server 202.

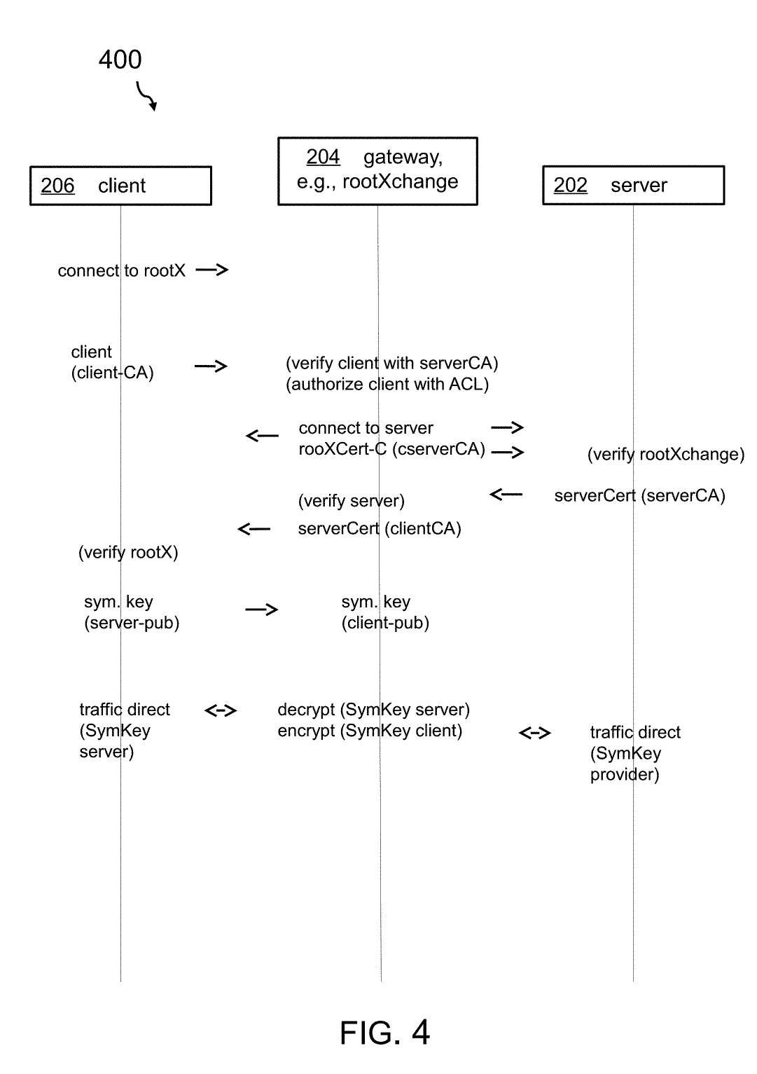

FIG. 4 shows a block diagram of a second embodiment of a data exchange/protocol diagram 400 for disclosed aspects. Also here, the expression in round bracket are activities performed by the different system, namely the client system 206 of a potential service provider, the trusted secure gateway 204 of a customer, as well as the server 202 of the customer of the service provider. The embodiment of FIG. 4 is shown with two pairs of symmetric keys: one for the connection from the client 206 to the trusted secure gateway 204, the other one from the trusted secure gateway 204 to the server 202. Thus, the trusted secure gateway is “a man in the middle” exchanging encryption.

As an example for reading the diagram: the client system, i.e., the service provider system sends a SYN message to the trusted secure gateway 204. Then, the trusted secure gateway 204 sends a SYN message to the server, i.e., to the serer of the service customers. Following that, the server 204 sends a SYN-ACK (synchronize acknowledge) message to the trusted secure gateway 204, which in turn sends a SYN-ACK back to the client system 206.

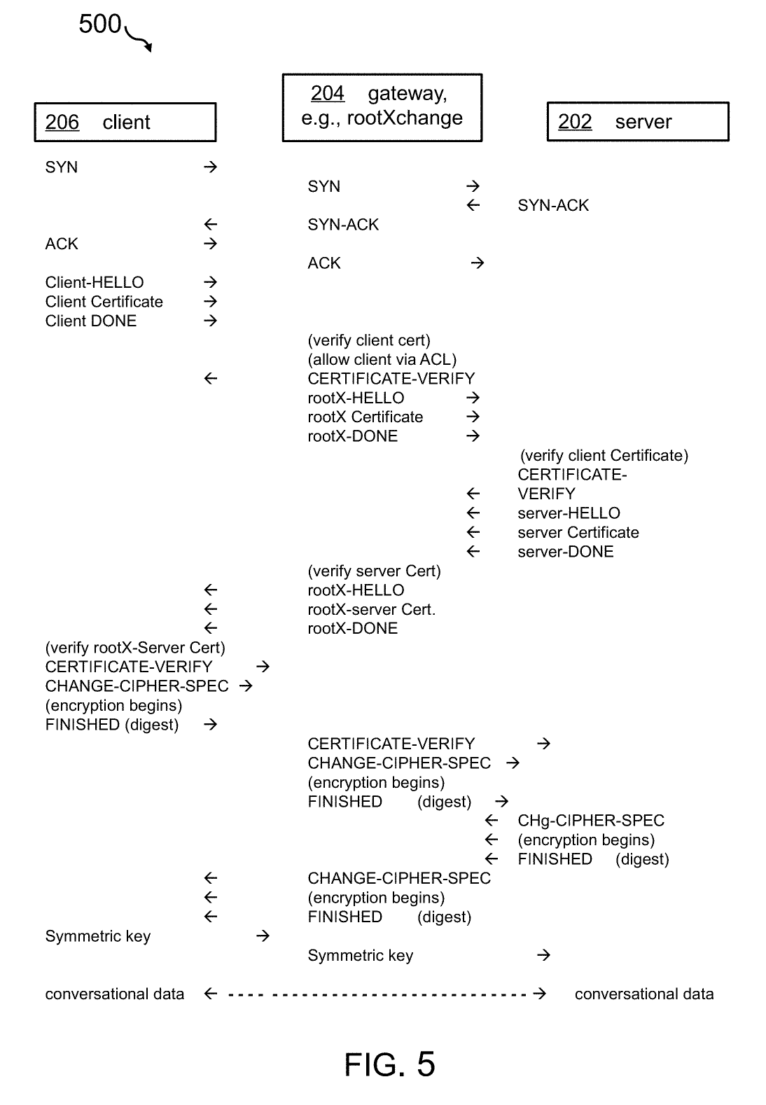

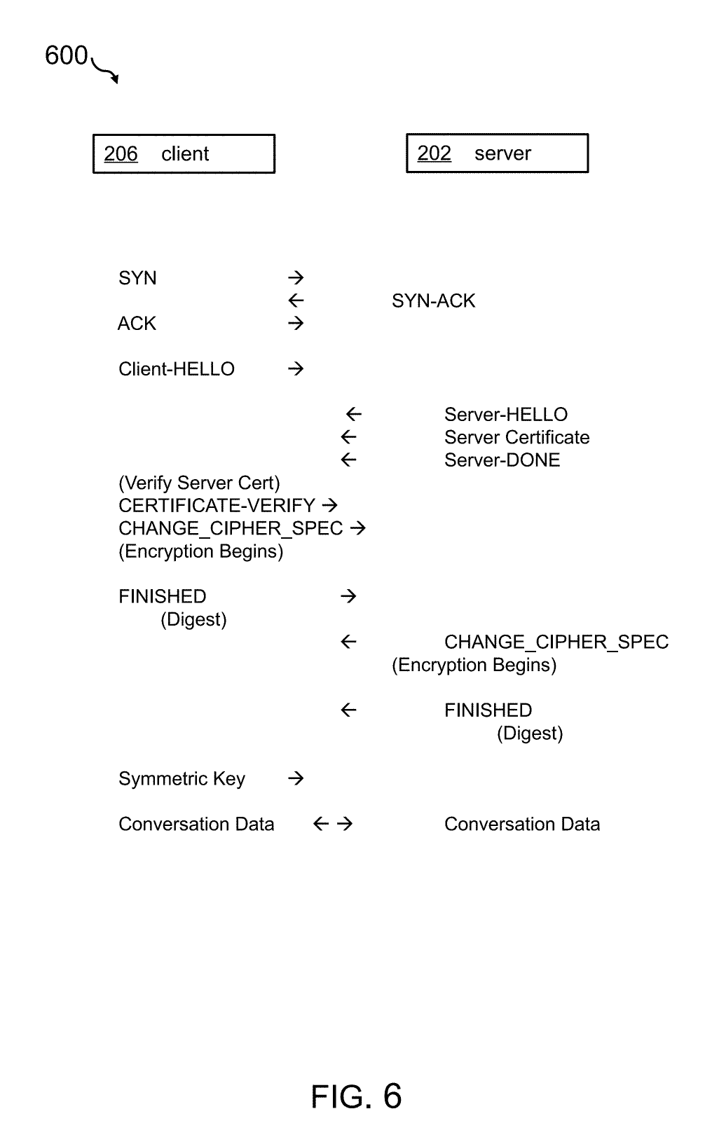

FIG. 5 shows a block diagram of a modified SSL flow 500 according to embodiments. The reading rules are equivalent to the ones if FIGS. 3 and 4. The remark “(digest”) in FIG. 5 may denote a copy of the protocol interaction ‘up to this point’ as seen from “the other side”—it allows both sides to verify that no one has tampered with the transmissions. The differences to a standard, known SSL flow 600—shown in FIG. 6 as reference—are easily notable. The standard SSL flow involves two constituents: here as example the client system 206 and the server 202. A core point is that during the establishing the communication connection, no direct contact happens between the client 206 and the server 202. The trusted secure gateway is always in control of the ensuring the only certified client system communicating to certified servers.

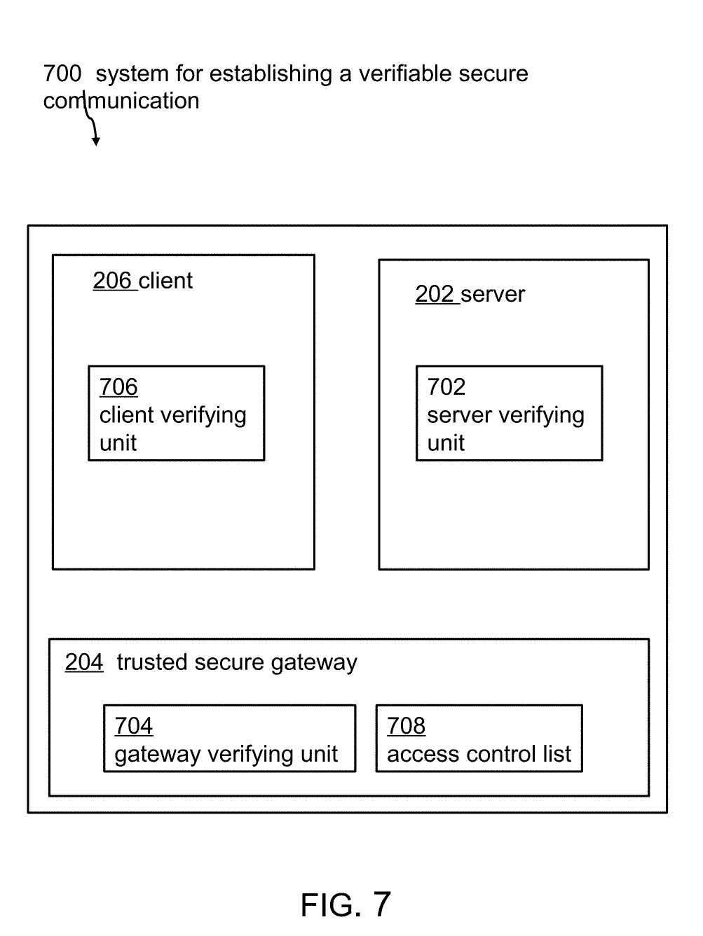

FIG. 7 shows a block diagram of an embodiment of the system 700 for establishing a verifiable secure communication connection between a server system 202 and a client system 206. A trusted gateway server 204 is used. The server 202 and the trusted gateway server 204 reside within a first network realm, wherein the server's public key certificates are signed by a certifying authority not certifiable from a the client residing within a second network realm different to the first network realm. The system 700 comprises a gateway verifying unit 704 in the trusted gateway server 204 adapted for verifying a certificate of the server 202 signed by a certificate authority of the first network realm before the communication connection between the server 202 and the client 206. The trusted gateway server 204 is trusted by the server 202. The gateway verifying unit 704 in the trusted gateway server 204 is also adapted for verifying a certificate of the client 206 signed by a certificate authority of the second network realm before establishing the communication connection between the server 202 and the client 206.

A client verifying unit 702 in the client 202 is adapted for verifying the trusted gateway server's certificate signed by a public key certificate signed by a certificate authority certifiable from the client's network before establishing the communication between the server 202 and the client 206.

The trusted secure gateway server 204 is adapted for establishing the communication connection between the server 202 to the client 206 and from the client 206 to the server 202 if authorized by an access control list 708 residing on the trusted secure gateway 204 server. The access control list 708 is indicative of allowed communication connections out of systems 202 of the first network realm (compare FIG. 2, 208) and into systems 202 of the first network realm (compare FIG. 2, 208).

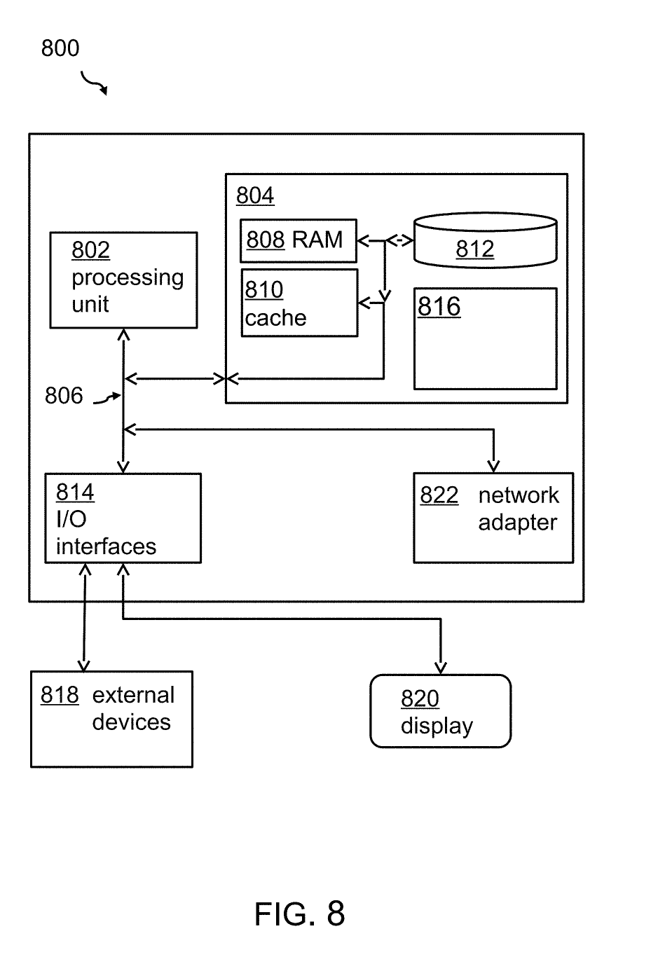

Embodiments of the invention may be implemented together with virtually any type of computer, regardless of the platform being suitable for storing and/or executing program code. FIG. 8 shows, as an example, a computing system 800 suitable for executing program code related to aspects of the disclosure. The server 202, the client 206 and/or the trusted secure gateway 204 may each be implemented as another embodiment of the computer system 800.

The computing system 800 is only one example of a suitable computer system and is not intended to suggest any limitation as to the scope of use or functionality of embodiments of the invention described herein. Regardless, computer system 800 is capable of being implemented and/or performing any of the functionality set forth hereinabove. In the computer system 800, there are components, which are operational with numerous other general purpose or special purpose computing system environments or configurations. Examples of well-known computing systems, environments, and/or configurations that may be suitable for use with computer system/server 800 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 800 may be described in the general context of computer system-executable instructions, such as program modules, being executed by a computer system 800. Generally, program modules may include routines, programs, objects, components, logic, data structures, and so on that perform particular tasks or implement particular abstract data types. Computer system/server 800 may be practiced in distributed cloud computing environments where tasks are performed by remote processing devices that are linked through a communications network. In a distributed cloud computing environment, program modules may be located in both local and remote computer system storage media including memory storage devices.

As shown in the figure, computer system/server 800 is shown in the form of a general-purpose computing device. The components of computer system/server 800 may include, but are not limited to, one or more processors or processing units 802, a system memory 804, and a bus 806 that couples various system components including system memory 804 to the processor 802. Bus 806 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 800 typically includes a variety of computer system readable media. Such media may be any available media that is accessible by computer system/server 800, and it includes both, volatile and non-volatile media, removable and non-removable media.

The system memory 804 may include computer system readable media in the form of volatile memory, such as random access memory (RAM) 808 and/or cache memory 810. Computer system/server 800 may further include other removable/non-removable, volatile/non-volatile computer system storage media. By way of example only, storage system 812 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 806 by one or more data media interfaces. As will be further depicted and described below, memory 804 may include at least one program product having a set (e.g., at least one) of program modules that are configured to carry out the functions of embodiments of the invention.

Program/utility 814, having a set (at least one) of program modules 816, may be stored in memory 804 by way of example, and not limitation, as well as an operating system, one or more application programs, other program modules, and program data. Each of the operating system, one or more application programs, other program modules, and program data or some combination thereof, may include an implementation of a networking environment. Program modules 816 generally carry out the functions and/or methodologies of embodiments of the invention as described herein.

The computer system/server 800 may also communicate with one or more external devices 818 such as a keyboard, a pointing device, a display 820, etc.; one or more devices that enable a user to interact with computer system/server 800; and/or any devices (e.g., network card, modem, etc.) that enable computer system/server 800 to communicate with one or more other computing devices. Such communication can occur via Input/Output (I/O) interfaces 814. Still yet, computer system/server 800 may communicate with one or more networks such as a local area network (LAN), a general wide area network (WAN), and/or a public network (e.g., the Internet) via network adapter 822. As depicted, network adapter 822 may communicate with the other components of computer system/server 800 via bus 806. It should be understood that although not shown, other hardware and/or software components could be used in conjunction with computer system/server 800. Examples, include, but are not limited to: microcode, device drivers, redundant processing units, external disk drive arrays, RAID systems, tape drives, and data archival storage systems, etc.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the disclosure may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A method for establishing a verifiable secure communication connection between a server and a client using a trusted secure gateway, wherein the server and the trusted secure gateway reside within a first network realm, wherein the server's public key certificates are signed by a certifying authority not certifiable from a the client residing within a second network realm different to the first network realm, the method comprising:
verifying, by the trusted secure gateway, a certificate of the server signed by a certificate authority of the first network realm before establishing the communication connection between the server and the client, wherein the trusted secure gateway is trusted by the server;
verifying, by the trusted secure gateway, a certificate of the client signed by a certificate authority of the second network realm before establishing the communication connection between the server and the client;
verifying, by the client, a certificate of the trusted secure gateway signed by a public key certificate authority certifiable from the client's network before establishing the communication between the server and the client; and
establishing, via the trusted secure gateway, the communication connection between the client and the server if authorized by an access control list residing on the trusted of the trusted secure gateway, the access control list being indicative of allowed communication connections out of systems of the first network realm and into systems of the first network realm.

2. The method according to claim 1, further comprising:
verifying, by the server, a certificate of the trusted secure gateway signed by the public key certificate authority certifiable from the server's network realm before establishing the communication connection between the server and the client.

3. The method according to claim 1, wherein the certificate authority of the second network realm is a local certificate authority of the client.

4. The method according to claim 1, wherein the certificate authority of the second network realm is a well-trusted 3rd party certificate authority.

5. The method according to claim 1, wherein:
the verifying, by the trusted secure gateway, the server's certificate represents an authentication of the server, and
the verifying, by the trusted secure gateway, the client's certificate represents an authentication of the client.

6. The method according to claim 1, wherein a first symmetric key is exchanged between the client and the trusted secure gateway, and a second symmetric key is exchanged between the server and the trusted secure gateway, wherein an inbound communication to the trusted secure gateway is decrypted by the first symmetric key before being encrypted with a the second symmetric key before being transmitted by the trusted secure gateway.

7. The method according to claim 1, further comprising:
exchanging a single symmetric key between the client and the server, wherein an inbound communication to the trusted secure gateway is transmitted directly without requiring decryption.

8. The method according to claim 1, further comprising:
exchanging a single symmetric key between the client and the server, wherein an inbound communication to the trusted secure gateway is transmitted directly without requiring re-encryption.

9. The method according to claim 1, further comprising:
exchanging a single symmetric key between the client and the server, wherein an inbound communication to the trusted secure gateway is transmitted directly without requiring decryption and re-encryption.

10. The method according to claim 1, wherein the trusted secure gateway performs a port-forwarding for a determination of a specific server in the first network realm to be connected to the client.

11. The method according to claim 1, wherein the trusted secure gateway acts as SOCKS5 proxy for a determination of a specific client in the second network realm is to be connected to the server.

12. The method according to claim 1, wherein the trusted secure gateway acts as HTTP proxy for a determination of a specific client in the second network realm is to be connected to the server.

13. The method according to claim 1, wherein the trusted secure gateway logs one or more accesses of one or more communication connections between one or more of the servers in the first network realm and one or more of the clients in the second network realm.

14. The method according to claim 1, wherein the trusted secure gateway logs all accesses of all communication connections between any of the servers in the first network realm and any of the clients in the second network realm.

15. The method according to claim 13, wherein the logging includes: one or more network addresses.

16. The method according to claim 13, wherein the logging includes: an access time.

17. The method according to claim 13, wherein the logging includes: a communication connection duration.

18. The method according to claim 13, wherein the logging includes: a verified public certificate of the client and the server.

19. A system for establishing a verifiable secure communication connection between a server and a client using a trusted secure gateway, wherein the server and the trusted secure gateway reside within a first network realm, wherein the server's public key certificates are signed by a certifying authority not certifiable from a the client residing within a second network realm different to the first network realm, the system comprising:
a memory having a set of computer readable computer instructions, and
a processor for executing the set of computer readable instructions, the set of computer readable instructions including:
verifying, by the trusted secure gateway, a certificate of the server signed by a certificate authority of the first network realm before establishing the communication connection between the server and the client, wherein the trusted secure gateway is trusted by the server;
verifying, by the trusted secure gateway, a certificate of the client signed by a certificate authority of the second network realm before establishing the communication connection between the server and the client;
verifying, by the client, a certificate of the trusted secure gateway signed by a public key certificate authority certifiable from the client's network before establishing the communication between the server and the client; and
establishing, via the trusted secure gateway, the communication connection between the client and the server if authorized by an access control list residing on the trusted of the trusted secure gateway, the access control list being indicative of allowed communication connections out of systems of the first network realm and into systems of the first network realm.

20. A computer program product for establishing a verifiable secure communication connection between a server and a client using a trusted secure gateway, wherein the server and the trusted secure gateway reside within a first network realm, wherein the server's public key certificates are signed by a certifying authority not certifiable from a the client residing within a second network realm different to the first network realm, the computer program product comprising a computer readable storage medium having program instructions embodied therewith, wherein the computer readable storage medium is not a transitory signal per se, the program instructions executable by a processor to cause the processor to perform a method comprising:
verifying, by the trusted secure gateway, a certificate of the server signed by a certificate authority of the first network realm before establishing the communication connection between the server and the client, wherein the trusted secure gateway is trusted by the server;
verifying, by the trusted secure gateway, a certificate of the client signed by a certificate authority of the second network realm before establishing the communication connection between the server and the client;
verifying, by the client, a certificate of the trusted secure gateway signed by a public key certificate authority certifiable from the client's network before establishing the communication between the server and the client; and
establishing, via the trusted secure gateway, the communication connection between the client and the server if authorized by an access control list residing on the trusted of the trusted secure gateway, the access control list being indicative of allowed communication connections out of systems of the first network realm and into systems of the first network realm.
